(19) United States
(12) Patent Application Publication
(10) Pub. No.: US 2024/0410715 A1
(43) Pub. Date: Dec. 12, 2024

(54) SYSTEMS AND METHODS FOR ALIGNING A PLURALITY OF LOCAL COMPUTER READABLE MAPS TO A SINGLE GLOBAL MAP AND DETECTING MAPPING ERRORS

(71) Applicant: Brain Corporation, San Diego, CA (US)

(72) Inventors: Girish Bathala, San Diego, CA (US); Jonathon Sather, San Diego, CA (US)

(21) Appl. No.: 18/809,548

(22) Filed: Aug. 20, 2024

Related U.S. Application Data
(63) Continuation of application No. PCT/US23/14329, filed on Mar. 2, 2023.
(60) Provisional application No. 63/315,943, filed on Mar. 2, 2022.

(51) Int. Cl. G01C 21/00

(52) U.S. Cl. CPC G01C 21/3811; G01C 21/3867

(57) ABSTRACT

Systems and methods for aligning a plurality of local computer readable maps to a single global map and detecting mapping errors are disclosed herein. According to at least one non-limiting exemplary embodiment, a robotic system is configured to produce a coverage report on a single, global map, while using multiple local routes and maps to effectuate autonomous operation. The coverage report is in a human readable format which does not require prior knowledge of the environment layout or accounting for repeated tasks between multiple disjoint local routes.

### PRIORITY

This application is a continuation of International Patent Application No. PCT/US23/14329 filed Mar. 2, 2023 and claims the benefit of U.S. Provisional Patent Application Ser. No. 63/315,943 filed on Mar. 2, 2022 under 35 U.S.C. § 119, the entire disclosure of which is incorporated herein by reference.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### Technological Field

The present application relates generally to robotics, and more specifically to systems and methods for aligning a plurality of local computer readable maps to a single global map and detecting mapping errors.

### SUMMARY

Currently, robots may operate in large environments and utilize computer readable maps to navigate therein, wherein use of large maps may be computationally taxing to process. Further, processing large maps may cause a robot to be unable to react quickly to changes as it is required to process mostly irrelevant data (e.g., consider objects far away from the robot which pose no risk of collision nor constrain path planning). Accordingly, many robots utilize smaller, local maps to navigate along singular routes and/or to execute a small set of tasks. These local routes may only map relevant areas sensed by the robot and omit other areas which are not impactful to the performance of the robot to reduce the cycle time in processing the map to generate path planning decisions. In many instances, humans may desire to review performance of their robots. For instance, if the robots are configured to deliver items, the humans working alongside the robots may desire to know when, where and which items were transferred. Displaying such information in piecemeal by displaying local maps one-by-one may be difficult for human reviewers to get a comprehensive understanding of the robot performance. For instance, the human reviewer may be required to have prior knowledge of where each local map corresponds to in the environment to understand where and when the robot has navigated somewhere. Accordingly, there is a need in the art for systems and methods which align a plurality of disjoint local routes onto a single global map while preserving the accuracy of robot performance and spatial mapping. Further, there is additional need in the art for systems and methods to ensure that such alignment is error free.

The foregoing needs are satisfied by the present disclosure, which provides for, inter alia, systems and methods for aligning a plurality of local computer readable maps to a single global map and detecting mapping errors.

Exemplary embodiments described herein have innovative features, no single one of which is indispensable or solely responsible for their desirable attributes. Without limiting the scope of the claims, some of the advantageous features will now be summarized. One skilled in the art would appreciate that as used herein, the term robot may generally be referred to autonomous vehicle or object that travels a route, executes a task, or otherwise moves automatically upon executing or processing computer readable instructions.

According to at least one non-limiting exemplary embodiment, a robotic system is disclosed. The robotic system, comprises: a non-transitory computer readable storage medium comprising a plurality of computer readable instructions stored thereon; and a controller configured to execute the computer readable instructions to: produce one or more computer readable maps during navigation of the robot along a route; impose a mesh over the one or more computer readable maps; align the one or more computer readable maps to a second computer readable map based on a first transformation; and adjust the mesh based on the first transformation.

According to at least one non-limiting exemplary embodiment, the controller is further configured to execute the computer readable instructions to: determine the first transformation based on an alignment of a set of features found on both the one or more computer readable maps and the second computer readable maps.

According to at least one non-limiting exemplary embodiment, the mesh is defined by a grid of points and the first transform comprises adjustment of the grid of the mesh.

According to at least one non-limiting exemplary embodiment, the mesh comprises a plurality of triangles and the first transform comprises manipulating an area encompassed within the triangles. According to at least one non-limiting exemplary embodiment, the controller is further configured to execute the computer readable instructions to: detect if one or more of the triangles have collapsed and determine the first transform yields a discontinuous map.

According to at least one non-limiting exemplary embodiment, the mesh defines a plurality of areas and the adjusting of the mesh comprises of one or more affine transformations of a respective one of the plurality of areas.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A is a functional block diagram of a robot in accordance with some embodiments of this disclosure.

FIG. 1B is a functional block diagram of a controller or processor in accordance with some embodiments of this disclosure.

FIG. 2A illustrates a light detection and ranging (“LiDAR”) sensor configured to generate points to localize objects in an environment, according to an exemplary embodiment.

FIG. 2B illustrates a point cloud generated by a LiDAR sensor, according to an exemplary embodiment.

FIG. 2C (i-iii) illustrate a process of scan matching to align one object to another, according to an exemplary embodiment.

FIG. 3A depicts a local computer readable map superimposed over a global computer readable map, according to an exemplary embodiment.

FIG. 3B depicts a local computer readable map comprising an erroneously localized object thereon, according to an exemplary embodiment.

FIG. 4A illustrates a grid of points superimposed over the local computer readable map, according to an exemplary embodiment.

FIG. 4B illustrates a mesh of areas superimposed over the local computer readable map, according to an exemplary embodiment.

FIG. 5A illustrates an alignment of an object on a local map to a location of the same object on a global map, according to an exemplary embodiment.

FIG. 5B illustrates a manipulation of a grid and/or mesh following an alignment of an object on a local map to its location on a global map, according to an exemplary embodiment.

FIG. 6 depicts an affine transform in accordance with some embodiments of this disclosure.

FIG. 7A depicts a local computer readable map comprising an erroneously localized object with a mesh superimposed thereon, according to an exemplary embodiment.

FIG. 7B depicts a local computer readable map aligned with a global map and a manipulated mesh as a result of the alignment, according to an exemplary embodiment.

FIG. 8 is a process flow diagram illustrating a method for a controller of a robot to align a local map to a global map, according to an exemplary embodiment.

FIG. 9 is a process flow diagram illustrating a method for a controller of a robot to generate a coverage report to a user, according to an exemplary embodiment.

FIG. 10 depicts a pose graph of a route navigated by a robot being sparsified via removing one node, according to an exemplary embodiment.

All Figures disclosed herein are ® Copyright 2023 Brain Corporation. All rights reserved.

### DETAILED DESCRIPTION

Various aspects of the novel systems, apparatuses, and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting, the scope of the disclosure being defined by the appended claims and equivalents thereof.

The present disclosure provides for systems and methods for aligning a plurality of local computer readable maps to a single global map and detecting mapping errors. As used herein, a robot may include mechanical and/or virtual entities configured to carry out a complex series of tasks or actions autonomously. In some exemplary embodiments, robots may be machines that are guided and/or instructed by computer programs and/or electronic circuitry. In some exemplary embodiments, robots may include electro-mechanical components that are configured for navigation, where the robot may move from one location to another. Such robots may include autonomous and/or semi-autonomous cars, floor cleaners, rovers, drones, planes, boats, carts, trams, wheelchairs, industrial equipment, stocking machines, mobile platforms, personal transportation devices (e.g., hover boards, SEGWAYS®, etc.), stocking machines, trailer movers, vehicles, and the like. Robots may also include any autonomous and/or semi-autonomous machine for transporting items, people, animals, cargo, freight, objects, luggage, and/or anything desirable from one location to another.

As used herein, a global map comprises of a computer readable map which includes the area of relevance for robotic operation. For instance, in a supermarket, a global map for a floor cleaning robot may comprise of the sales floor, but is not required to comprise of staff rooms where the robot never operates. Global maps may be generated by navigating the robot under a manual control, user guided control, or in an exploration mode. Global maps are rarely utilized for navigation due to their size being larger than what is required to navigate the robot, which may cause operational issues in processing large, mostly irrelevant data for each motion planning cycle.

As used herein, the term ‘global’ may refer to an entirety of an object. For instance, a global map of an environment is a map that represents the entire environment as used/sensed by a robot. As another example, global optimization of a map refers to an optimization performed on the entire map.

As used herein, the term ‘local’ may refer to a sub-section of a larger portion. For instance, performing a local optimization on a map as used herein would refer to performing an optimization on a sub-section of the map, such as a select region or group of pixels, rather than the entire map.

As used herein, a local map comprises of a computer readable map used by a robot to navigate a route or execute a task. Such local maps often only include objects sensed during navigation of a route or execution of a task and omit additional areas beyond what is needed to effectuate autonomous operation. That is, local maps only include a mapped area of a sub-section of the environment which is related to the task performed by the robot. Such local maps each include an origin from which locations on the local maps are defined. It is appreciated, however, that a plurality of local maps, each comprising a different origin point in the physical world, may be utilized by a robot, whereby it is useful align all these local maps to a single origin point to, e.g., provide useful performance reports.

As used herein, network interfaces may include any signal, data, or software interface with a component, network, or process including, without limitation, those of the FireWire (e.g., FW400, FW800, FWS800T, FWS1600, FWS3200, etc.), universal serial bus (“USB”) (e.g., USB 1.X. USB 2.0, USB 3.0, USB Type-C, etc.), Ethernet (e.g., 10/100, 10/100/1000 (Gigabit Ethernet), 10-Gig-E, etc.), multimedia over coax alliance technology (“MoCA”), Coaxsys (e.g., TVNET™), radio frequency tuner (e.g., in-band or OOB, cable modem, etc.), Wi-Fi (802.11), WiMAX (e.g., WiMAX (802.16)), PAN (e.g., PAN/802.15), cellular (e.g., 3G, 4G, or 5G including LTE/LTE-A/TD-LTE/TD-LTE, GSM, etc. variants thereof), IrDA families, etc. As used herein, Wi-Fi may include one or more of IEEE-Std. 802.11, variants of IEEE-Std. 802.11, standards related to IEEE-Std. 802.11 (e.g., 802.11 a/b/g/n/ac/ad/af/ah/ai/aj/aq/ax/ay), and/or other wireless standards.

As used herein, processor, microprocessor, and/or digital processor may include any type of digital processing device such as, without limitation, digital signal processors (“DSPs”), reduced instruction set computers (“RISC”), complex instruction set computers (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, and application-specific integrated circuits (“ASICs”). Such digital processors may be contained on a single unitary integrated circuit die or distributed across multiple components.

As used herein, computer program and/or software may include any sequence or human or machine cognizable steps which perform a function. Such computer program and/or software may be rendered in any programming language or environment including, for example, C/C++, C#, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

As used herein, connection, link, and/or wireless link may include a causal link between any two or more entities (whether physical or logical/virtual), which enables information exchange between the entities.

As used herein, computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming data signal.

Detailed descriptions of the various embodiments of the system and methods of the disclosure are now provided. While many examples discussed herein may refer to specific exemplary embodiments, it will be appreciated that the described systems and methods contained herein are applicable to any kind of robot. Myriad other embodiments or uses for the technology described herein would be readily envisaged by those having ordinary skill in the art, given the contents of the present disclosure.

Advantageously, the systems and methods of this disclosure at least: (i) provide human readable performance reports for robots; (ii) allow for non-uniform transforms while preserving spatial geometry of local maps; and (iii) enable robots to detect divergences or errors in local maps. Other advantages are readily discernable by one having ordinary skill in the art given the contents of the present disclosure.

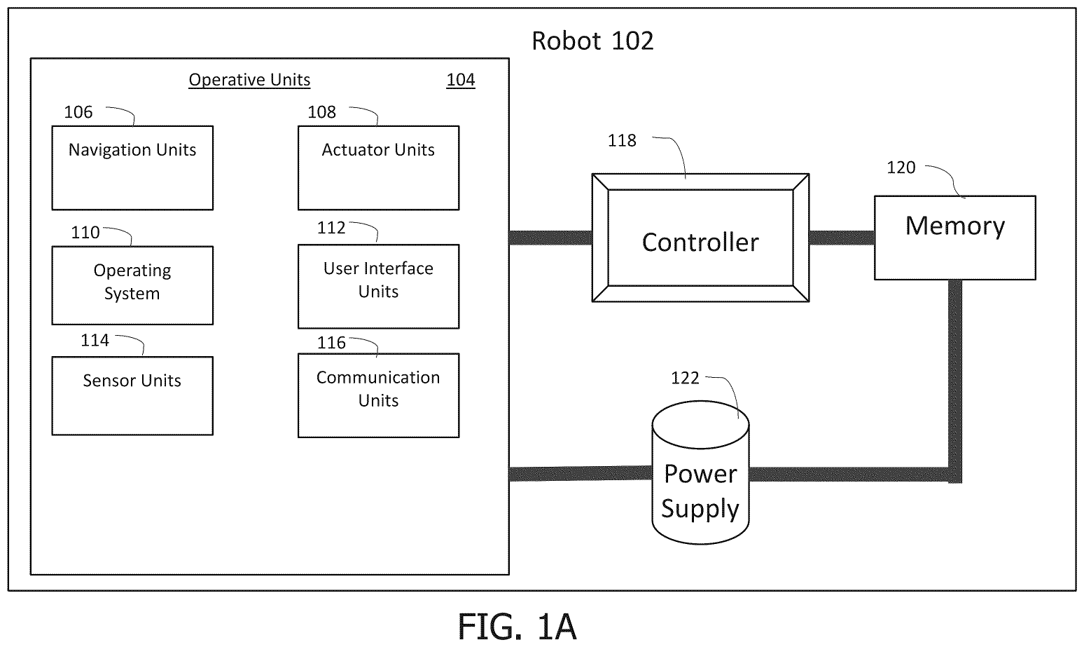

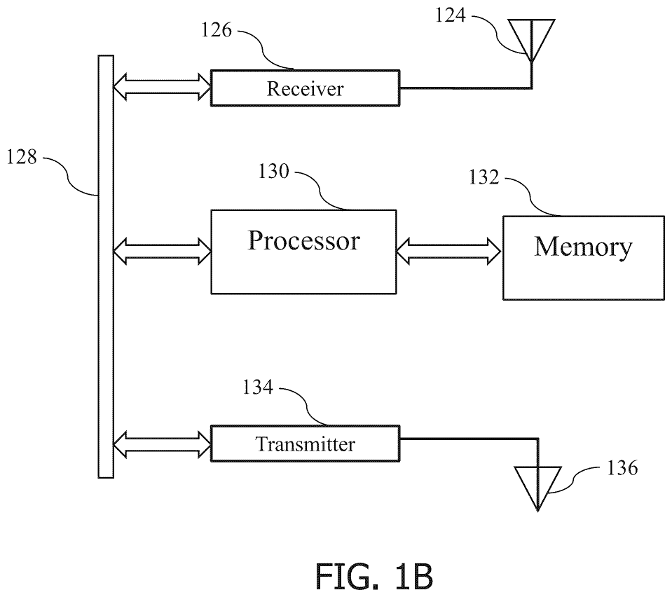

FIG. 1A is a functional block diagram of a robot 102 in accordance with some principles of this disclosure. As illustrated in FIG. 1A, robot 102 may include controller 118, memory 120, user interface unit 112, sensor units 114, navigation units 106, actuator unit 108, and communications unit 116, as well as other components and subcomponents (e.g., some of which may not be illustrated). Although a specific embodiment is illustrated in FIG. 1A, it is appreciated that the architecture may be varied in certain embodiments as would be readily apparent to one of ordinary skill given the contents of the present disclosure. As used herein, robot 102 may be representative at least in part of any robot described in this disclosure.

Controller 118 may control the various operations performed by robot 102. Controller 118 may include and/or comprise one or more processing devices (e.g., microprocessing devices) and other peripherals. As previously mentioned and used herein, processing device, microprocessing device, and/or digital processing device may include any type of digital processing device such as, without limitation, digital signal processing devices (“DSPs”), reduced instruction set computers (“RISC”), complex instruction set computers (“CISC”), microprocessing devices, gate arrays (e.g., field programmable gate arrays (“FPGAs”)), programmable logic device (“PLDs”), reconfigurable computer fabrics (“RCFs”), array processing devices, secure microprocessing devices and application-specific integrated circuits (“ASICs”). Peripherals may include hardware accelerators configured to perform a specific function using hardware elements such as, without limitation, encryption/description hardware, algebraic processing devices (e.g., tensor processing units, quadric problem solvers, multipliers, etc.), data compressors, encoders, arithmetic logic units (“ALU”), and the like. Such digital processing devices may be contained on a single unitary integrated circuit die, or distributed across multiple components.

Controller 118 may be operatively and/or communicatively coupled to memory 120. Memory 120 may include any type of integrated circuit or other storage device configured to store digital data including, without limitation, read-only memory (“ROM”), random access memory (“RAM”), non-volatile random access memory (“NVRAM”), programmable read-only memory (“PROM”), electrically erasable programmable read-only memory (“EEPROM”), dynamic random-access memory (“DRAM”), Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e.g., NAND/NOR), memristor memory, pseudostatic RAM (“PSRAM”), etc. Memory 120 may provide computer-readable instructions and data to controller 118. For example, memory 120 may be a non-transitory, computer-readable storage apparatus and/or medium having a plurality of instructions stored thereon, the instructions being executable by a processing apparatus (e.g., controller 118) to operate robot 102. In some cases, the computer-readable instructions may be configured to, when executed by the processing apparatus, cause the processing apparatus to perform the various methods, features, and/or functionality described in this disclosure. Accordingly, controller 118 may perform logical and/or arithmetic operations based on program instructions stored within memory 120. In some cases, the instructions and/or data of memory 120 may be stored in a combination of hardware, some located locally within robot 102, and some located remote from robot 102 (e.g., in a cloud, server, network, etc.).

It should be readily apparent to one of ordinary skill in the art that a processing device may be internal to or on board robot 102 and/or may be external to robot 102 and be communicatively coupled to controller 118 of robot 102 utilizing communication units 116 wherein the external processing device may receive data from robot 102, process the data, and transmit computer-readable instructions back to controller 118. In at least one non-limiting exemplary embodiment, the processing device may be on a remote server (not shown).

In some exemplary embodiments, memory 120, shown in FIG. 1A, may store a library of sensor data. In some cases, the sensor data may be associated at least in part with objects and/or people. In exemplary embodiments, this library may include sensor data related to objects and/or people in different conditions, such as sensor data related to objects and/or people with different compositions (e.g., materials, reflective properties, molecular makeup, etc.), different lighting conditions, angles, sizes, distances, clarity (e.g., blurred, obstructed/occluded, partially off frame, etc.), colors, surroundings, and/or other conditions. The sensor data in the library may be taken by a sensor (e.g., a sensor of sensor units 114 or any other sensor) and/or generated automatically, such as with a computer program that is configured to generate/simulate (e.g., in a virtual world) library sensor data (e.g., which may generate/simulate these library data entirely digitally and/or beginning from actual sensor data) from different lighting conditions, angles, sizes, distances, clarity (e.g., blurred, obstructed/occluded, partially off frame, etc.), colors, surroundings, and/or other conditions. The number of images in the library may depend at least in part on one or more of the amount of available data, the variability of the surrounding environment in which robot 102 operates, the complexity of objects and/or people, the variability in appearance of objects, physical properties of robots, the characteristics of the sensors, and/or the amount of available storage space (e.g., in the library, memory 120, and/or local or remote storage). In exemplary embodiments, at least a portion of the library may be stored on a network (e.g., cloud, server, distributed network, etc.) and/or may not be stored completely within memory 120. As yet another exemplary embodiment, various robots (e.g., that are commonly associated, such as robots by a common manufacturer, user, network, etc.) may be networked so that data captured by individual robots are collectively shared with other robots. In such a fashion, these robots may be configured to learn and/or share sensor data in order to facilitate the ability to readily detect and/or identify errors and/or assist events.

Still referring to FIG. 1A, operative units 104 may be coupled to controller 118, or any other controller, to perform the various operations described in this disclosure. One, more, or none of the modules in operative units 104 may be included in some embodiments. Throughout this disclosure, reference may be to various controllers and/or processing devices. In some embodiments, a single controller (e.g., controller 118) may serve as the various controllers and/or processing devices described. In other embodiments different controllers and/or processing devices may be used, such as controllers and/or processing devices used particularly for one or more operative units 104. Controller 118 may send and/or receive signals, such as power signals, status signals, data signals, electrical signals, and/or any other desirable signals, including discrete and analog signals to operative units 104. Controller 118 may coordinate and/or manage operative units 104, and/or set timings (e.g., synchronously or asynchronously), turn off/on control power budgets, receive/send network instructions and/or updates, update firmware, send interrogatory signals, receive and/or send statuses, and/or perform any operations for running features of robot 102.

Returning to FIG. 1A, operative units 104 may include various units that perform functions for robot 102. For example, operative units 104 includes at least navigation units 106, actuator units 108, user interface units 112, sensor units 114, and communication units 116. Operative units 104 may also comprise other units such as specifically configured task units (not shown) that provide the various functionality of robot 102. In exemplary embodiments, operative units 104 may be instantiated in software, hardware, or both software and hardware. For example, in some cases, units of operative units 104 may comprise computer implemented instructions executed by a controller. In exemplary embodiments, units of operative unit 104 may comprise hardcoded logic (e.g., ASICS). In exemplary embodiments, units of operative units 104 may comprise both computer-implemented instructions executed by a controller and hardcoded logic. Where operative units 104 are implemented in part in software, operative units 104 may include units/modules of code configured to provide one or more functionalities.

In exemplary embodiments, navigation units 106 may include systems and methods that may computationally construct and update a map of an environment, localize robot 102 (e.g., find the position) in a map, and navigate robot 102 to/from destinations. The mapping may be performed by imposing data obtained in part by sensor units 114 into a computer-readable map representative at least in part of the environment. In exemplary embodiments, a map of an environment may be uploaded to robot 102 through user interface units 112, uploaded wirelessly or through wired connection, or taught to robot 102 by a user.

In exemplary embodiments, navigation units 106 may include components and/or software configured to provide directional instructions for robot 102 to navigate. Navigation units 106 may process maps, routes, and localization information generated by mapping and localization units, data from sensor units 114, and/or other operative units 104.

Still referring to FIG. 1A, actuator units 108 may include actuators such as electric motors, gas motors, driven magnet systems, solenoid/ratchet systems, piezoelectric systems (e.g., inchworm motors), magnetostrictive elements, gesticulation, and/or any way of driving an actuator known in the art. By way of illustration, such actuators may actuate the wheels for robot 102 to navigate a route; navigate around obstacles; rotate cameras and sensors. According to exemplary embodiments, actuator unit 108 may include systems that allow movement of robot 102, such as motorize propulsion. For example, motorized propulsion may move robot 102 in a forward or backward direction, and/or be used at least in part in turning robot 102 (e.g., left, right, and/or any other direction). By way of illustration, actuator unit 108 may control if robot 102 is moving or is stopped and/or allow robot 102 to navigate from one location to another location.

Actuator unit 108 may also include any system used for actuating and, in some cases actuating task units to perform tasks. For example, actuator unit 108 may include driven magnet systems, motors/engines (e.g., electric motors, combustion engines, steam engines, and/or any type of motor/engine known in the art), solenoid/ratchet system, piezoelectric system (e.g., an inchworm motor), magnetostrictive elements, gesticulation, and/or any actuator known in the art.

According to exemplary embodiments, sensor units 114 may comprise systems and/or methods that may detect characteristics within and/or around robot 102. Sensor units 114 may comprise a plurality and/or a combination of sensors. Sensor units 114 may include sensors that are internal to robot 102 or external, and/or have components that are partially internal and/or partially external. In some cases, sensor units 114 may include one or more exteroceptive sensors, such as sonars, light detection and ranging (“LiDAR”) sensors, radars, lasers, cameras (including video cameras (e.g., red-blue-green (“RBG”) cameras, infrared cameras, three-dimensional (“3D”) cameras, thermal cameras, etc.), time of flight (“ToF”) cameras, structured light cameras, etc.), antennas, motion detectors, microphones, and/or any other sensor known in the art. According to some exemplary embodiments, sensor units 114 may collect raw measurements (e.g., currents, voltages, resistances, gate logic, etc.) and/or transformed measurements (e.g., distances, angles, detected points in obstacles, etc.). In some cases, measurements may be aggregated and/or summarized. Sensor units 114 may generate data based at least in part on distance or height measurements. Such data may be stored in data structures, such as matrices, arrays, queues, lists, arrays, stacks, bags, etc.

According to exemplary embodiments, sensor units 114 may include sensors that may measure internal characteristics of robot 102. For example, sensor units 114 may measure temperature, power levels, statuses, and/or any characteristic of robot 102. In some cases, sensor units 114 may be configured to determine the odometry of robot 102. For example, sensor units 114 may include proprioceptive sensors, which may comprise sensors such as accelerometers, inertial measurement units (“IMU”), odometers, gyroscopes, speedometers, cameras (e.g. using visual odometry), clock/timer, and the like. Odometry may facilitate autonomous navigation and/or autonomous actions of robot 102. This odometry may include robot 102's position (e.g., where position may include robot's location, displacement and/or orientation, and may sometimes be interchangeable with the term pose as used herein) relative to the initial location. Such data may be stored in data structures, such as matrices, arrays, queues, lists, arrays, stacks, bags, etc. According to exemplary embodiments, the data structure of the sensor data may be called an image.

According to exemplary embodiments, sensor units 114 may be in part external to the robot 102 and coupled to communications units 116. For example, a security camera within an environment of a robot 102 may provide a controller 118 of the robot 102 with a video feed via wired or wireless communication channel(s). In some instances, sensor units 114 may include sensors configured to detect a presence of an object at a location such as, for example without limitation, a pressure or motion sensor may be disposed at a shopping cart storage location of a grocery store, wherein the controller 118 of the robot 102 may utilize data from the pressure or motion sensor to determine if the robot 102 should retrieve more shopping carts for customers.

According to exemplary embodiments, user interface units 112 may be configured to enable a user to interact with robot 102. For example, user interface units 112 may include touch panels, buttons, keypads/keyboards, ports (e.g., universal serial bus (“USB”), digital visual interface (“DVI”), Display Port, E-Sata, Firewire, PS/2, Serial, VGA, SCSI, audioport, high-definition multimedia interface (“HDMI”), personal computer memory card international association (“PCMCIA”) ports, memory card ports (e.g., secure digital (“SD”) and miniSD), and/or ports for computer-readable medium), mice, rollerballs, consoles, vibrators, audio transducers, and/or any interface for a user to input and/or receive data and/or commands, whether coupled wirelessly or through wires. Users may interact through voice commands or gestures. User interface units 218 may include a display, such as, without limitation, liquid crystal display (“LCDs”), light-emitting diode (“LED”) displays, LED LCD displays, in-plane-switching (“IPS”) displays, cathode ray tubes, plasma displays, high definition (“HD”) panels, 4K displays, retina displays, organic LED displays, touchscreens, surfaces, canvases, and/or any displays, televisions, monitors, panels, and/or devices known in the art for visual presentation. According to exemplary embodiments user interface units 112 may be positioned on the body of robot 102. According to exemplary embodiments, user interface units 112 may be positioned away from the body of robot 102 but may be communicatively coupled to robot 102 (e.g., via communication units including transmitters, receivers, and/or transceivers) directly or indirectly (e.g., through a network, server, and/or a cloud). According to exemplary embodiments, user interface units 112 may include one or more projections of images on a surface (e.g., the floor) proximally located to the robot, e.g., to provide information to the occupant or to people around the robot. The information could be the direction of future movement of the robot, such as an indication of moving forward, left, right, back, at an angle, and/or any other direction. In some cases, such information may utilize arrows, colors, symbols, etc.

According to exemplary embodiments, communications unit 116 may include one or more receivers, transmitters, and/or transceivers. Communications unit 116 may be configured to send/receive a transmission protocol, such as BLUETOOTH®, ZIGBEE®, Wi-Fi, induction wireless data transmission, radio frequencies, radio transmission, radio-frequency identification (“RFID”), near-field communication (“NFC”), infrared, network interfaces, cellular technologies such as 3G (3.5G, 3.75G, 3GPP/3GPP2/HSPA+), 4G (4GPP/4GPP2/LTE/LTE-TDD/LTE-FDD), 5G (5GPP/5GPP2), or 5G LTE (long-term evolution, and variants thereof including LTE-A, LTE-U, LTE-A Pro, etc.), high-speed downlink packet access (“HSDPA”), high-speed uplink packet access (“HSUPA”), time division multiple access (“TDMA”), code division multiple access (“CDMA”) (e.g., IS-95A, wideband code division multiple access (“WCDMA”), etc.), frequency hopping spread spectrum (“FHSS”), direct sequence spread spectrum (“DSSS”), global system for mobile communication (“GSM”), Personal Area Network (“PAN”) (e.g., PAN/802.15), worldwide interoperability for microwave access (“WiMAX”), 802.20, long term evolution (“LTE”) (e.g., LTE/LTE-A), time division LTE (“TD-LTE”), global system for mobile communication (“GSM”), narrowband/frequency-division multiple access (“FDMA”), orthogonal frequency-division multiplexing (“OFDM”), analog cellular, cellular digital packet data (“CDPD”), satellite systems, millimeter wave or microwave systems, acoustic, infrared (e.g., infrared data association (“IrDA”)), and/or any other form of wireless data transmission.

Communications unit 116 may also be configured to send/receive signals utilizing a transmission protocol over wired connections, such as any cable that has a signal line and ground. For example, such cables may include Ethernet cables, coaxial cables, Universal Serial Bus (“USB”), Fire Wire, and/or any connection known in the art. Such protocols may be used by communications unit 116 to communicate to external systems, such as computers, smart phones, tablets, data capture systems, mobile telecommunications networks, clouds, servers, or the like. Communications unit 116 may be configured to send and receive signals comprising of numbers, letters, alphanumeric characters, and/or symbols. In some cases, signals may be encrypted, using algorithms such as 128-bit or 256-bit keys and/or other encryption algorithms complying with standards such as the Advanced Encryption Standard (“AES”), RSA, Data Encryption Standard (“DES”), Triple DES, and the like. Communications unit 116 may be configured to send and receive statuses, commands, and other data/information. For example, communications unit 116 may communicate with a user operator to allow the user to control robot 102. Communications unit 116 may communicate with a server/network (e.g., a network) in order to allow robot 102 to send data, statuses, commands, and other communications to the server. The server may also be communicatively coupled to computer(s) and/or device(s) that may be used to monitor and/or control robot 102 remotely. Communications unit 116 may also receive updates (e.g., firmware or data updates), data, statuses, commands, and other communications from a server for robot 102.

In exemplary embodiments, operating system 110 may be configured to manage memory 120, controller 118, power supply 122, modules in operative units 104, and/or any software, hardware, and/or features of robot 102. For example, and without limitation, operating system 110 may include device drivers to manage hardware recourses for robot 102.

In exemplary embodiments, power supply 122 may include one or more batteries, including, without limitation, lithium, lithium ion, nickel-cadmium, nickel-metal hydride, nickel-hydrogen, carbon-zinc, silver-oxide, zinc-carbon, zinc-air, mercury oxide, alkaline, or any other type of battery known in the art. Certain batteries may be rechargeable, such as wirelessly (e.g., by resonant circuit and/or a resonant tank circuit) and/or plugging into an external power source. Power supply 122 may also be any supplier of energy, including wall sockets and electronic devices that convert solar, wind, water, nuclear, hydrogen, gasoline, natural gas, fossil fuels, mechanical energy, steam, and/or any power source into electricity.

One or more of the units described with respect to FIG. 1A (including memory 120, controller 118, sensor units 114, user interface unit 112, actuator unit 108, communications unit 116, mapping and localization unit 126, and/or other units) may be integrated onto robot 102, such as in an integrated system. However, according to some exemplary embodiments, one or more of these units may be part of an attachable module. This module may be attached to an existing apparatus to automate so that it behaves as a robot. Accordingly, the features described in this disclosure with reference to robot 102 may be instantiated in a module that may be attached to an existing apparatus and/or integrated onto robot 102 in an integrated system. Moreover, in some cases, a person having ordinary skill in the art would appreciate from the contents of this disclosure that at least a portion of the features described in this disclosure may also be run remotely, such as in a cloud, network, and/or server.

As used herein, a robot 102, a controller 118, or any other controller, processing device, or robot performing a task, operation or transformation illustrated in the figures below comprises a controller executing computer readable instructions stored on a non-transitory computer readable storage apparatus, such as memory 120, as would be appreciated by one skilled in the art.

Next referring to FIG. 1B, the architecture of a processor or processing device 138 is illustrated according to an exemplary embodiment. As illustrated in FIG. 1B, the processing device 138 includes a data bus 128, a receiver 126, a transmitter 134, at least one processor 130, and a memory 132. The receiver 126, the processor 130 and the transmitter 134 all communicate with each other via the data bus 128. The processor 130 is configurable to access the memory 132 which stores computer code or computer readable instructions in order for the processor 130 to execute the specialized algorithms. As illustrated in FIG. 1B, memory 132 may comprise some, none, different, or all of the features of memory 120 previously illustrated in FIG. 1A. The algorithms executed by the processor 130 are discussed in further detail below. The receiver 126 as shown in FIG. 1B is configurable to receive input signals 124. The input signals 124 may comprise signals from a plurality of operative units 104 illustrated in FIG. 1A including, but not limited to, sensor data from sensor units 114, user inputs, motor feedback, external communication signals (e.g., from a remote server), and/or any other signal from an operative unit 104 requiring further processing. The receiver 126 communicates these received signals to the processor 130 via the data bus 128. As one skilled in the art would appreciate, the data bus 128 is the means of communication between the different components-receiver, processor, and transmitter—in the processing device. The processor 130 executes the algorithms, as discussed below, by accessing specialized computer-readable instructions from the memory 132. Further detailed description as to the processor 130 executing the specialized algorithms in receiving, processing and transmitting of these signals is discussed above with respect to FIG. 1A. The memory 132 is a storage medium for storing computer code or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium may include volatile, nonvolatile, dynamic, static, read/write, read-only, random-access, sequential-access, location-addressable, file-addressable, and/or content-addressable devices. The processor 130 may communicate output signals to transmitter 134 via data bus 128 as illustrated. The transmitter 134 may be configurable to further communicate the output signals to a plurality of operative units 104 illustrated by signal output 136.

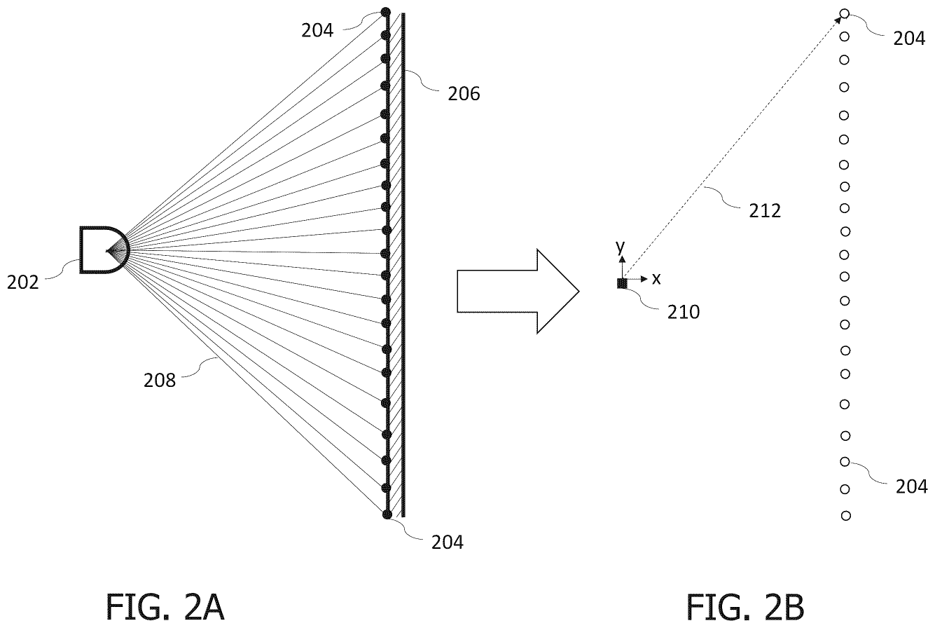

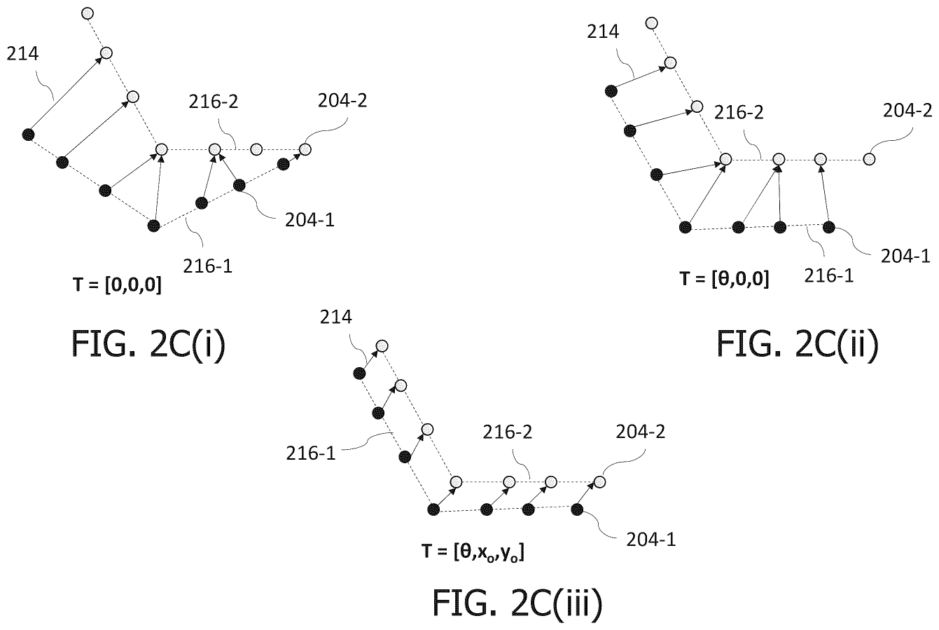

One of ordinary skill in the art would appreciate that the architecture illustrated in FIG. 1B may illustrate an external server architecture configurable to effectuate the control of a robotic apparatus from a remote location, such as server 202 illustrated next in FIG. 2. That is, the server may also include a data bus, a receiver, a transmitter, a processor, and a memory that stores specialized computer readable instructions thereon.

One of ordinary skill in the art would appreciate that a controller 118 of a robot 102 may include one or more processing devices 138 and may further include other peripheral devices used for processing information, such as ASICS, DPS, proportional-integral-derivative (“PID”) controllers, hardware accelerators (e.g., encryption/decryption hardware), and/or other peripherals (e.g., analog to digital converters) described above in FIG. 1A. The other peripheral devices when instantiated in hardware are commonly used within the art to accelerate specific tasks (e.g., multiplication, encryption, etc.) which may alternatively be performed using the system architecture of FIG. 1B. In some instances, peripheral devices are used as a means for intercommunication between the controller 118 and operative units 104 (e.g., digital to analog converters and/or amplifiers for producing actuator signals). Accordingly, as used herein, the controller 118 executing computer readable instructions to perform a function may include one or more processing devices 138 thereof executing computer readable instructions and, in some instances, the use of any hardware peripherals known within the art. Controller 118 may be illustrative of various processing devices 138 and peripherals integrated into a single circuit die or distributed to various locations of the robot 102 which receive, process, and output information to/from operative units 104 of the robot 102 to effectuate control of the robot 102 in accordance with instructions stored in a memory 120, 132. For example, controller 118 may include a plurality of processing devices 138 for performing high level tasks (e.g., planning a route to avoid obstacles) and processing devices 138 for performing low-level tasks (e.g., producing actuator signals in accordance with the route).

FIG. 2A illustrates a planar light detection and ranging (“LiDAR”) sensor 202 coupled to a robot 102, which collects distance measurements to a wall 206 along a measurement plane in accordance with some exemplary embodiments of the present disclosure. Planar LiDAR sensor 202, illustrated in FIG. 2A, may be configured to collect distance measurements to the wall 206 by projecting a plurality of beams 208 of photons at discrete angles along a measurement plane and determining the distance to the wall 206 based on a time of flight (“ToF”) of the photons leaving the LiDAR sensor 202, reflecting off the wall 206, and returning back to the LiDAR sensor 202. The measurement plane of the planar LiDAR 202 comprises a plane along which the beams 208 are emitted which, for this exemplary embodiment illustrated, is the plane of the page.

Individual beams 208 of photons may localize respective points 204 of the wall 206 in a point cloud, the point cloud comprising a plurality of points 204 localized in 2D or 3D space as illustrated in FIG. 2B. The points 204 may be defined about a local origin 210 of the sensor 202. Distance 212 to a point 204 may comprise half the time of flight of a photon of a respective beam 208 used to measure the point 204 multiplied by the speed of light, wherein coordinate values (x, y) of each respective point 204 depends both on distance 212 and an angle at which the respective beam 208 was emitted from the sensor 202. The local origin 210 may comprise a predefined point of the sensor 202 to which all distance measurements are referenced (e.g., location of a detector within the sensor 202, focal point of a lens of sensor 202, etc.). For example, a 5-meter distance measurement to an object corresponds to 5 meters from the local origin 210 to the object.

According to at least one non-limiting exemplary embodiment, sensor 202 may be illustrative of a depth camera or other ToF sensor configurable to measure distance, wherein the sensor 202 being a planar LiDAR sensor is not intended to be limiting. Depth cameras may operate similar to planar LiDAR sensors (i.e., measure distance based on a ToF of beams 208); however, depth cameras may emit beams 208 using a single pulse or flash of electromagnetic energy, rather than sweeping a laser beam across a field of view. Depth cameras may additionally comprise a two-dimensional field of view rather than a one-dimensional, planar field of view.

According to at least one non-limiting exemplary embodiment, sensor 202 may be illustrative of a structured light LiDAR sensor configurable to sense distance and shape of an object by projecting a structured pattern onto the object and observing deformations of the pattern. For example, the size of the projected pattern may represent distance to the object and distortions in the pattern may provide information of the shape of the surface of the object. Structured light sensors may emit beams 208 along a plane as illustrated or in a predetermined pattern (e.g., a circle or series of separated parallel lines).

FIG. 2C (i-iii) illustrate the scan matching process at three various stages, according to an exemplary embodiment. Scan matching, as used herein, involves aligning a first set of measurements or scans from a sensor or sensors with another second set of measurements or scan from the same sensor(s). The alignment yields a transformation T comprising a matrix of rotations, θ, and translations, [x, y], which, when applied to the first scan, causes the first scan to align with the second scan. Alignment may be determined when the cumulative distance between all points of the first scan to their respective closest points of the second scan is at a minimum, which may be determined upon any rotation or translation being applied to the first scan causes the cumulative distance to increase.

FIG. 2C (i-iii) are illustrated within a frame of reference of a sensor 202 coupled to a robot 102. The frame of reference is centered about the sensor origin 210. Accordingly, if the robot 102 moves, the sensor 202 and its origin 210 moves, wherein static objects will exhibit apparent motion within the frame of reference of the sensor origin 210.

First, with reference to FIG. 2C (i), a first set of points 204-1 are measured by a sensor 202 followed by a second set of points 204-2, according to the exemplary embodiment. The first and second set of points 204 may be, for example, two subsequent measurements by a sensor of a robot 102 while the robot 102 moves. An object 216 may generate the plurality of points, wherein movement caused by the robot 102 causes the sensor 202 to sense the object 216 in a different location.

A controller 118 of the robot 102 may, for each point 204-1 of the first set of points, calculate the nearest neighboring point 204-2 of the second set of points, as shown by distances 214. The cumulative sum of the distances 214 will be minimized by the scan matching process. It may be appreciated by a skilled artisan that the nearest neighboring point of the second set may not be a point which corresponds to the same location on the object 216.

In the illustrated embodiment, the controller 118 may apply a first rotation of θ shown next in FIG. 2C (ii), according to the exemplary embodiment. Such rotation may cause some distances 214 to decrease (e.g., in the top left of FIG. 2C (i)) such that the cumulative sum of the distances 214 is reduced upon applying the rotation of θ to the first set of points 204-1. The rotation θ is applied about the origin 210 of the sensor, which corresponds to the center of the coordinate system within the sensor frame of reference.

Next, the controller 118 may determine that any further rotations of +40 would cause the sum of distances 214 to increase. Accordingly, in FIG. 2C (iii) the controller 118 has applied a translation to the first set of points 204-1 which further reduce the distances 214, according to the exemplary embodiment. The translation may comprise of translating along the x-axis by an amount of xₒ and along the y axis by an amount of yₒ. Accordingly, the transform T now includes angular rotation (FIG. 2C (ii)) and translation (FIG. 2C (iii)) components. The controller 118 may continue to translate the first set of points 204-1 until the cumulative distances 214 cannot be reduced further.

In some instances, the controller 118 may then attempt to rotate the first set of points again to further reduce the distances 214. Commonly, many scan matching algorithms (e.g., pyramid scan matching, iterative closest point, etc.) involve the controller 118 iterating through many small rotations, then small translations, then back to rotations etc. until the distances 214 are minimized and cannot be further reduced by any additional rotation or translation, thereby resulting in the final translation T. In this example, the object 216 is a static object, wherein the apparent misalignment of the two scans is the result of movement of the robot 102. Accordingly, the transform T in FIG. 2C (iii) may represent the translation and rotation undergone by the robot 102 between acquisition of the first set of points 204-1 and the second set of points 204-2.

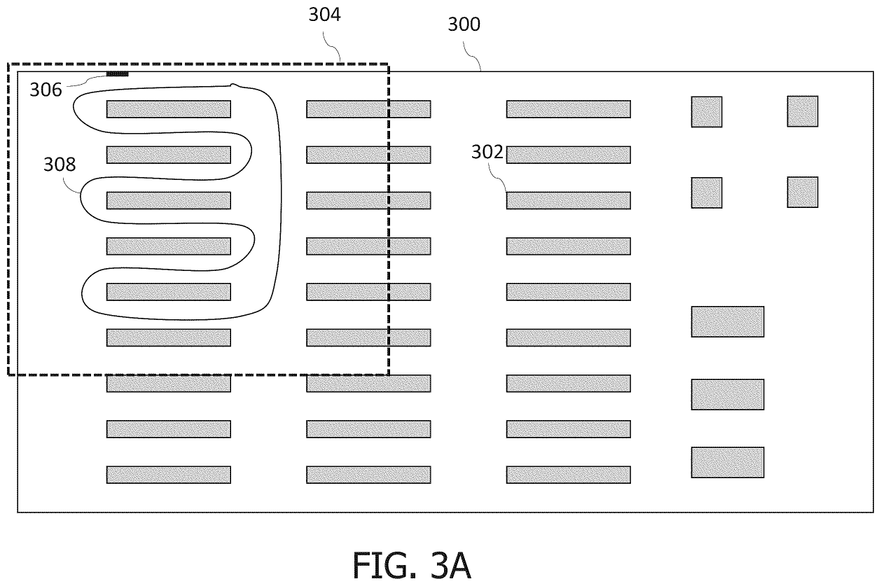

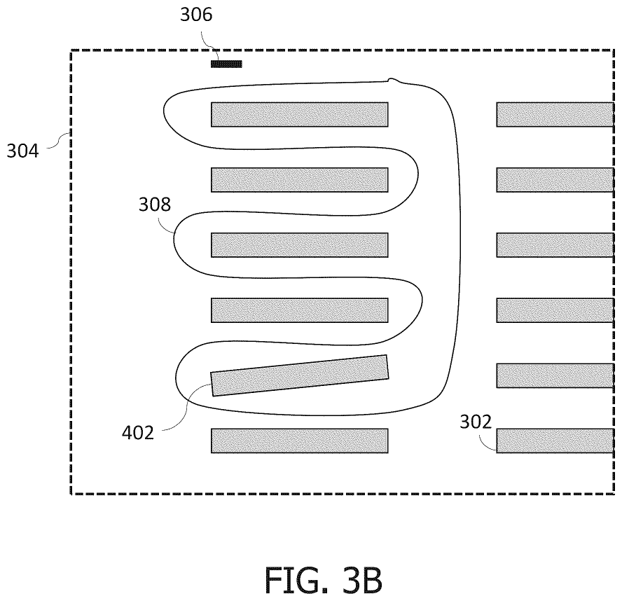

FIG. 3A illustrates a computer readable map 300 of an environment in which a robot 102 operates, according to an exemplary embodiment. Computer readable map 300 may be produced by a robot 102 via data collected from its sensor units 114 during operation, training, and/or manual (i.e., non-autonomous or semi-autonomous) usage. Large maps 300 may be useful to humans in viewing the map by giving large scale context but may be computationally taxing for a robot 102 to utilize for navigation. For example, for a floor cleaning robot 102, it may be desirable to view the area cleaned by the robot 102 on a global map 300 of the entire environment, rather than locally on local maps 304.

Superimposed on the computer readable map 300 is a local map 304 (represented by dotted lines) produced during navigation of a local route 308. Local route 308 may include a path for the robot 102 to execute its various tasks; however, the route 308 does not necessarily involve the robot 102 traveling to every location of the map 300. Local route 308 may begin and/or end proximate to a marker 306 comprising of a beacon (e.g., ultrasonic, radio-frequency, Wi-Fi, visual light, and/or other beacons), a familiar feature, a binary image (e.g., bar or quick-response codes), and/or other static and detectable features, or alternatively non-static detectable features. The marker 306 may provide the local route 308 with an origin, i.e., a (0,0) starting point from which the coordinates of the route 308 may be defined.

Controller 118 of the robot 102 may, upon detecting a marker 306, recognize one or more routes 308 associated with the particular marker 306. Those routes 308 may each correspond to a local map produced during, e.g., a prior execution of the routes 308. In executing the local routes 308, controller 118 may utilize the corresponding local map 304 rather than the global map 300 to reduce the amount of data (i.e., map pixels) required to be processed for path planning. To align the local map 304 to the global map 300 involves scan matching at least one same feature of the local map 304 to the location of that feature on the global map 300 as illustrated in FIG. 2C (i-iii) above. The more objects 302 in common between the global map 300 and local map 304, the more accurate alignment will yield.

At small scales, such as the 7 points considered in FIG. 2C (i-iii), a single uniform transform T may be sufficient to accurately overlap the local map 304 to the global map 300. However, often it is the case where local maps 304 include local map and error corrections, which would not be uniformly applied to all points of the local map 304. Similarly, applying a single uniform to the entire local map 304 to align it to the global map 300 may work locally in some scan-matched areas, yet fail in others. Accordingly, there is a need in the art to determine a transform which aligns the local map 304 to the global map 300 which considers small non-uniform (and non-isometric) transformations performed on the local scale. Such transform may be utilized to rapidly switch between a global map frame of reference and a local map frame of reference which aids humans in reviewing the activities of the robots 102 while preserving operational efficiency of the local maps used by the robots 102 to navigate. Further, the ability to switch reference frames may enable a robot 102 currently using local, disjointed maps to use a single, global map as a method to, e.g., reduce memory space used by computer readable maps.

FIG. 3B illustrates the local map 304 previously shown in FIG. 3A above with a grid 400 superimposed thereon, according to an exemplary embodiment. With reference to FIG. 3B, the local map 304 appears substantially similar to the map shown in FIG. 3A, however, one object 402 of the plurality of objects 302 is rotated slightly. The rotation of object 402 may be caused by a plurality of factors including, but not limited to, imperfect localization (e.g., underestimation of the turn before encountering object 402), noise, reflections causing imperfect ToF sensor 202 measurements, and/or as a result of other optimizations/constraints (e.g., as a solution given the constraint of the closed loop route 308). Although such misalignment may be present, for navigation along route 308 such small errors may not impact the performance of the robot 102 in navigating the route 308 and/or executing its tasks using the local map 304. Further, misalignments may occur and change after every execution of the route 308 wherein the robot 102 collects new data to synthesize into the map 304. Thus, the method of transforming the local map 304 to a global map 300 must account for small, local scale non-isometric misalignments between the global map 300 and local map 304.

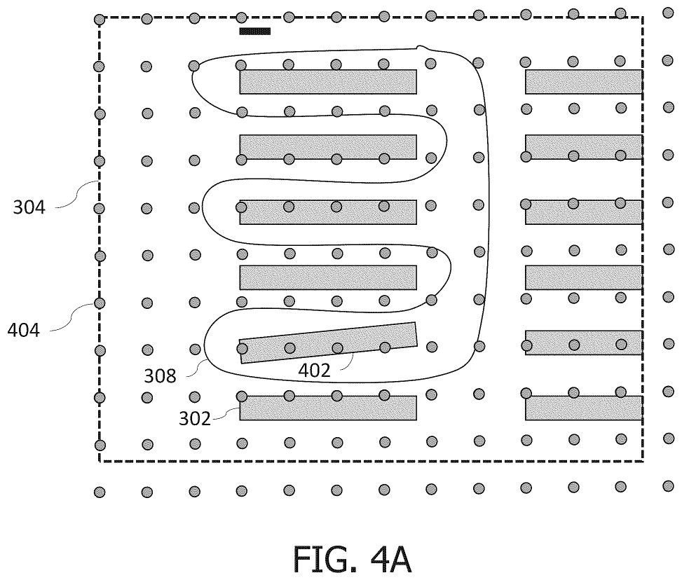

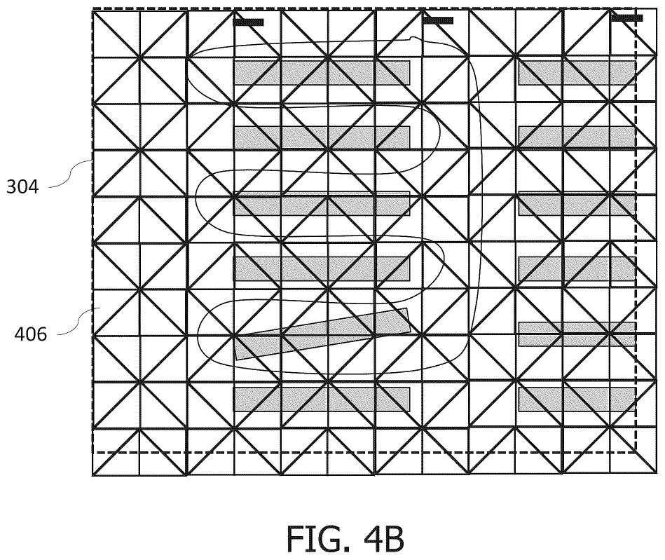

To determine such transform, FIG. 4A illustrates the same local map 304 including a grid of points 404 superimposed thereon, according to an exemplary embodiment. The points 404 of the grid are spaced equidistant from each other along the vertical and horizontal axis. From these gridded points 204, various triangles 406 may be drawn as shown in FIG. 4B, according to the exemplary embodiment. The triangles 406 include right-angle triangles of equal size.

The gridded points 404 and triangles 406 will provide a reference mesh which can be manipulated on local scales, as will be shown next. It is appreciated, however, that there is no requirement the gridded points 404 and/or triangles 406 drawn therefrom be uniformly distributed, wherein any non-uniform initial reference mesh would be equally as applicable. There is further no need for the gridded points 404 to be aligned with any particular object or feature of the local map 304 and can be initialized arbitrarily.

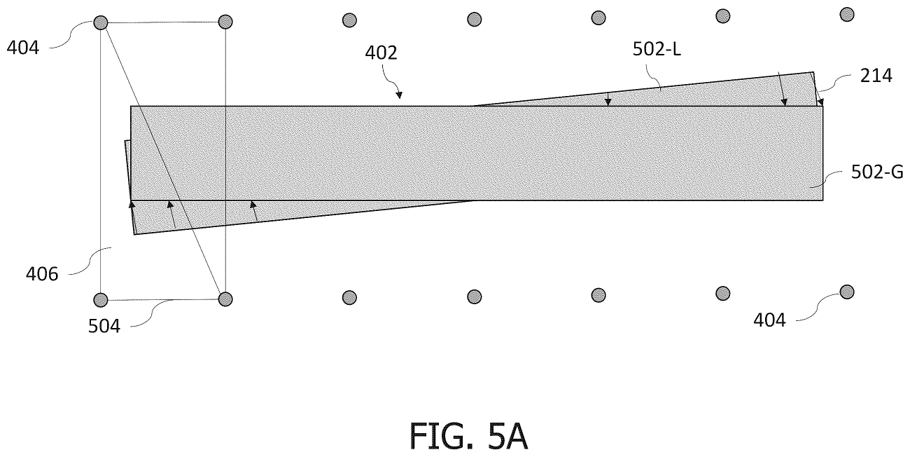

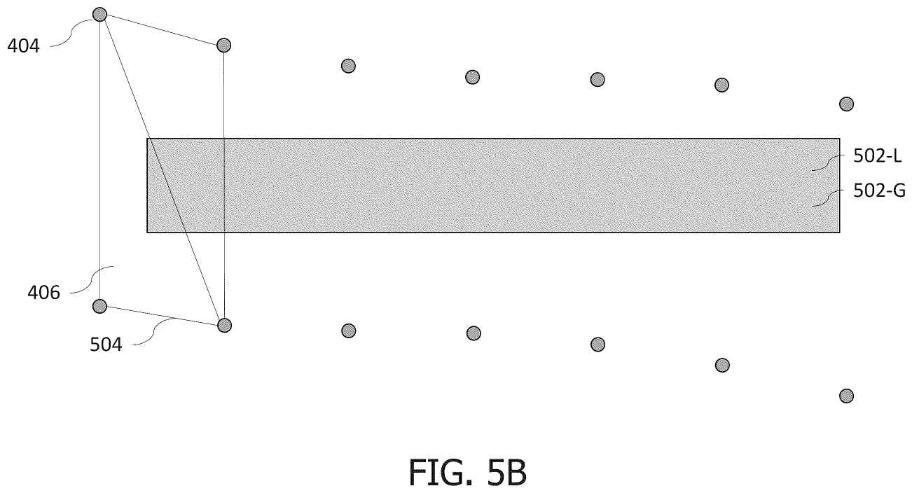

FIG. 5A illustrates a close-up view of the misaligned object 402 on the local map 304, denoted by position 502-L, superimposed onto its corresponding location 502-G on the global map 300, according to an exemplary embodiment. It may be assumed that, until now, the controller 118 has aligned the local map 304 to the global map 300 using a scan matching process and a single uniform transform T. For example, T may be determined by aligning a location of a home marker 306 of the local map 304 to its location on the global map 300. However, as mentioned above, such uniform transformation may yield misalignment on local scales due to non-uniform optimizations and changes made to the local map 304. Stated another way, the scan matching process may translate the map 304 shown in FIG. 3B, including the misaligned object 402, onto the global map 300, wherein the local map 304 and global map 300 may disagree on the location/position of the object 402.

The object 402 has been denoted in FIG. 5A in location 502-L, corresponding to its location on the local map 304, and in location 502-G, corresponding to its location on the global map 300. It is appreciated that the objects 502-L. 502-G may comprise of a plurality of points 204 and/or pixels, individual points/pixels of which have been omitted for clarity. As shown in FIG. 4A above, a plurality of points 404 have been placed in an approximate grid format. Vertices 504 of triangles 406 may be determined from the grid of points 404. The points 404 of the grid may be maintained at the location of the pixels of the local map 304, wherein manipulation of such pixels on the local map 304 will cause similar or same manipulations of the points 404.

To illustrate the manipulation of the points 404, a scan matching process as described in FIG. 2C (i-iii) above may be utilized, as shown by distances 214. The scan matching process in FIG. 5A-B is now localized to areas where there exist discrepancies, shown by distances 214, between the local map 304 and global map 300. Distances 214 may represent, for each point 204 or pixel of the object 502-L, the distance to the nearest neighboring point 204 or pixel of the object 502-G, wherein the controller 118 of the robot 102 applies various rotations and translations to some or all of the points/pixels of the object 502-L to minimize the distances 214. For simplicity, only a translation error about the center point of the object 502 is illustrated, however one skilled in the art may appreciate various other scenarios, which may cause misalignment between an object location 502-L and 502-G. For example, the object 502-L on the local map 304 may comprise of a different shape than object 502-G, such as when only one side of the object 502-L detected during navigation of the local route 308 but wholly detected on the global map 300, or vice versa.

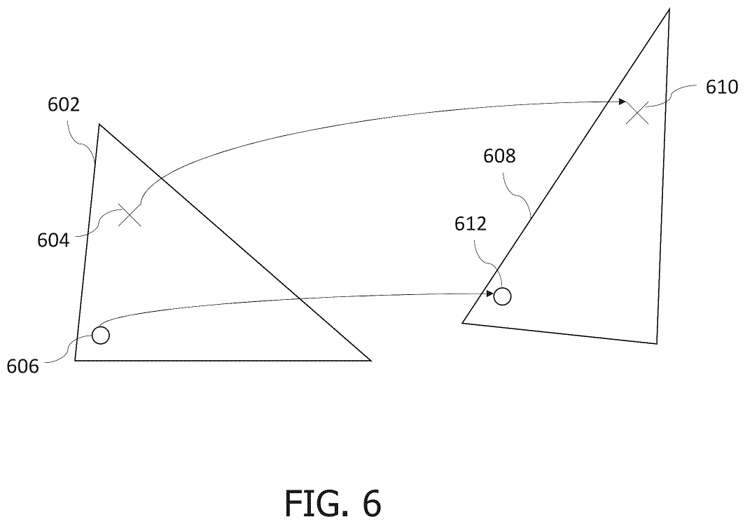

Upon minimizing the distances 214, the objects 502-L and 502-G may substantially align as shown next in FIG. 5B, according to the exemplary embodiment. In accordance with the transformations performed by the scan matching process, the points 404 have also been correspondingly manipulated. For example, the top left point 404 may be maintained at an equal distance from the top left corner of object 502-L as the object 502-L is rotated, and/or other points of reference. In some instances, the top left point 404 position may also be impacted by other changes and transforms performed on other parts of the computer readable map not shown for clarity. A more in-depth illustration and description of this transform, also referred to as an affine transform, is provided in FIG. 6 below.

Due to the manipulation of the points 404, the triangles 406 change in shape. More specifically, the spatial geometry within the triangles is maintained using an affine transform as the size/shape of the triangles morphs in accordance with the modifications to the pixels encompassed therein. These triangles, also commonly referred to as Delaunay triangles, define local scale transformations which, when performed on the local map 304, cause the local map 304 to align with the global map 300. Accordingly, once the local map 304 aligns with the global map 300 and all points 404 are manipulated, the grid of points 404 may define a non-uniform transform which causes the local map 304 to align with the global map. Thus, allowing the controller 118 to accurately switch between the local map 304 and global map 300. As discussed above, it may be advantageous to humans working alongside the robot 102 to synthesize the tasks and actions executed by the robot 102 on a single, global map or report. For example, robot 102 may be a floor cleaning robot, wherein the human may want to know how much of the total floor area was cleaned in the entire environment, rather than the amount of floor area cleaned on a local map. In this exemplary scenario, use of the global map may also further allow for consideration of areas which were cleaned multiple times during execution of different local routes as a single cleaned area, whereas use of multiple local maps would require a summation and prior environmental knowledge by the human of which areas on each local map have repeated cleaning action. Lastly, if during the process of alignment one or more of the triangles 406 collapse (i.e., shrink to below a threshold size) or flip, the presence of an error in either the local or global maps may be detected.

FIGS. 5A-B depict an object 502-L on a local map 304 being aligned with another object 502-G on the global map 300, however it is appreciated by those skilled in the art that manipulation of the object 502-L pose may be a result of manipulating the position of the robot 102 during acquisition of the sensory data which sensed the object 502-L, rather than manipulating object 502-L pixels themselves. For instance, with reference to FIG. 2A, consider the wall 206 to be localized on a first local map, but in a different position on the global map. Rather than manipulate the points 204 on the wall, the controller 118 can rotate/translate the sensor origin 210 while maintaining the length of rays 208, thereby causing the points 204 on the local map to align with the corresponding object on the global map. Typically, robotic systems are defined with respect to a single origin point, such as the center point in between wheels of an axel, which could be in or outside of the body of the robot 102 (e.g., on the floor). This origin point defines the (x, y) position of the robot 102 in its environment. Since each sensor origin 210 is at a known location with respect to the robot 102 origin and continuously measured by the controller 118 (also known as calibration), the robot 102 origin may be rotated/translated to effect the alignment of the object 502-L to the object 502-G as shown.

FIG. 6 depicts an affine transform in accordance with the embodiments of this disclosure. An affine transform preserves the parallelism and lines within the original structure of, for example, shape 602 but not necessarily the distances or angles. Affine transforms may also be considered as warping, rotating, sheering, and/or translating an initial shape 602 to a different shape 608 while preserving the spatial mapping of the area/points within the initial shape 602. For example, two points 604, 606 are illustrated in the initial shape 606. The two points 604, 606 are chosen randomly and may be representative of pixels of a local map 304, wherein the triangle 602 encompasses a portion of a local map 304. The initial shape 602 may be warped, sheered, rotated, etc. to produce a new shape 608. An affine transform may then be utilized to transfer the points 604, 606 onto their corresponding locations 610, 612. Accordingly, every point within the initial shape 602 also exists within the new shape 608, but in a new location.

Analogizing the shapes 602, 608 to a local computer readable map 304, the two points 604, 606 may represent pixels of the map 304 within a triangle 406. After optimizing the computer readable map 304, the pixels which were initially in the triangles 406 may be transformed using an affine transform to their respective locations within the new shape 608. For example, the initial triangle 602 may represent a portion of the local map 304 shown in FIG. 4B or 5A, whereas the modified triangle represents the scenario shown in FIG. 5B. One skilled in the art may appreciate, however, that a computer readable map includes discrete pixels of fixed size, wherein the local map 304 pre and post optimization would include the same number of pixels each representing the same area in the physical world. Accordingly, in some instances, pixels may be lost or generated during sheering, stretching, and/or warping operations as more or less area is present in the new shape 608 than the initial shape 602. For instance, with reference to FIG. 5A-B, the post-optimized triangles 406 (FIG. 5B) include slightly more area than the initial triangles 406 (FIG. 5A). A pixel of the post optimized triangle 406 may be counted as occupied by an object (e.g., 502) if the corresponding point in the initial triangle 406, defined by the affine transform, is also occupied, and/or vice versa for other pixel states (e.g., free space).

Affine transformations may include sheers, rotations, translations, reflections, and/or scaling. As previously discussed, the transformation of the map mesh may be used to detect mapping errors. For instance, a weighted summation of the amount of sheering, rotating, translating, reflecting, and/or scaling may be compared to a threshold value in some embodiments, wherein the summation exceeding the threshold would indicate a potential erroneous local map 304 due to the transformations being substantially large.

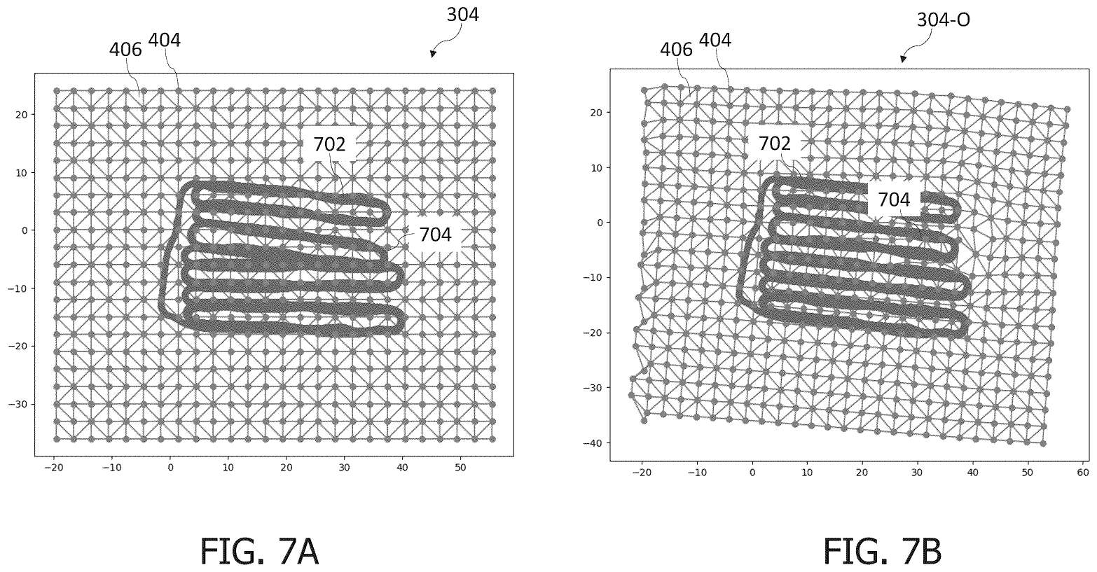

FIG. 7A illustrates a local map 304 prior to optimizations which align it to a global map 300, according to an exemplary embodiment. The local map 304 includes a route 702 thereon, which includes a plurality of switchbacks, or S-shaped patterns, which weave a robot 102 between various objects, similar to the route 308 shown in FIGS. 3-4 above. In executing the route 702, the controller 118 of the robot 102 may utilize the map 304 as, despite the errors, the map 304 may still be sufficiently accurate to facilitate autonomous operation, namely path planning. However, it may be desirable for a human to view the computer readable map 304 to determine the actions taken by the robot 102, wherein an erroneously localized switchback 704 may be visually confusing for a human viewer. As shown in FIG. 7A, the switchback 704 overlaps with another adjacent path portion making it difficult for a human viewer to discern where the robot 102 has traveled. Further, the human may desire to view the path 702 traveled on a global map of the entire environment rather than a local section thereof. Accordingly, the local map 304 may be aligned to a different global map 300, wherein scan matching may cause local non-isometric transforms to the route 702 and objects on the map 304 (omitted for clarity), as shown in FIG. 5A-B. The local transforms are shown by the difference between the meshes of map 304 and 304-0, wherein the map 304-O comprises a plurality of non-uniform triangles 406 due to local adjustments made to only the switchback 704. By preserving the spatial mapping within each of the triangles 406 of the mesh, the mesh is manipulated as shown in FIG. 7B. As shown in FIG. 7B, once local map 304 is aligned with the global map to produce an optimized local map 304-O, various small-scale non-uniform transforms may be utilized as shown by the non-uniform triangles 406 proximate to the modified switchback 704. Accordingly, the modified mesh shown in FIG. 7B may be stored in memory 120 to enable the robot 102 to translate its path 702 executed on the local map 304 onto the global map 300 while preserving the spatial geometry of the environment.

Additionally, as discussed above, if the alignment process fails to properly align the local map 304 to a global map 300, such failure would be reflected in the modified mesh via one or more of the triangles 406 flipping or collapsing to near zero size. For example, had the erroneous switchback 704 been scan match aligned to overlay onto the above or below switchback, one or more of the triangles 406 would flip, thereby indicating a poor alignment and/or an erroneous local map 304.

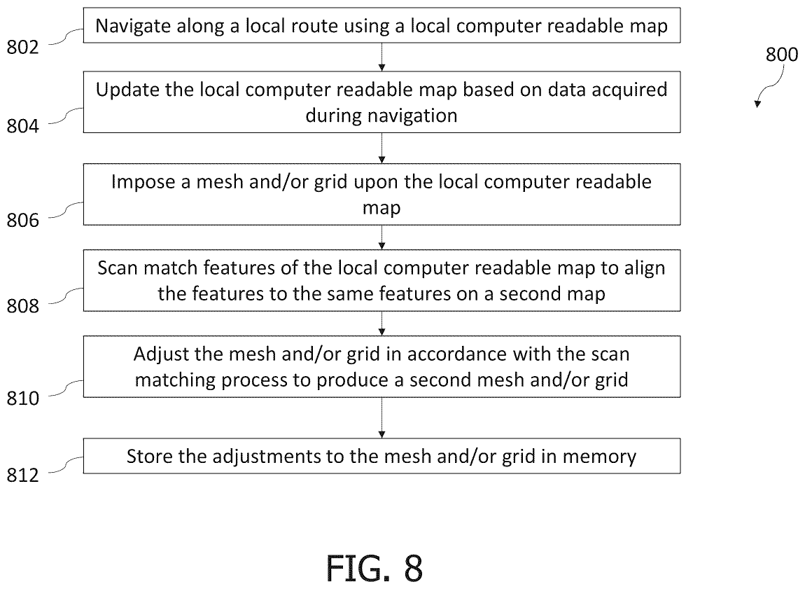

FIG. 8 is a process flow diagram illustrating a method 800 for a controller 118 of a robot 102 to generate, modify and store a mesh in accordance with non-uniform optimizations performed on a local map 304, according to an exemplary embodiment. Steps of method 800 are effectuated via the controller 118 executing instructions from non-transitory computer readable storage medium, such as memory 120.

Block 802 includes the controller 118 navigating the robot 102 using a local route on a local map. In using the local map, the controller 118 may cause the robot 102 to execute various tasks the robot 102 is assigned to execute. In other words, block 802 includes the robot 102 operating normally and producing a computer readable map using data from sensor units 114. In some embodiments, the local map comprises an origin defined with respect to the initial starting location of the robot 102, wherein the origin may be different than the origin used by the global map.

Block 804 includes the controller 118 updating the local map using any new data collected during navigation of the local route in block 802. The controller 118 may, for every local map stored in its memory 120, update the respective local map with new data as the new data is acquired during autonomous operation.

Block 806 includes the controller 118 imposing a mesh and/or grid upon the local computer readable map. Although previous figures have shown the mesh including equally spaced points 404 connected to form triangles 406, one skilled in the art may appreciate that such mesh is not required to be uniform and can be any initial arrangement. Imposing of the mesh onto the local map forms a plurality of areas, represented by triangles 406. In some embodiments, triangles 406 may alternatively be squares. In later optimization operations, the spatial geometry within the triangles 406 is to be preserved under warps, rotations, sheers, and translations via an affine transform.

Block 808 includes the controller 118 scan matching features of the local map to align with the same features on a second, global map. The scan matching process may be a non-uniform process including a plurality of local optimizations or manipulations of pixels of the local map which cause the pixels of the local map to align with pixels of the global map, namely the pixels which represent objects.

Block 810 includes the controller 118 adjusting the mesh and/or grid in accordance with the scan match process in block 808 to produce a second, modified mesh. Using an affine transform which preserves the spatial mapping of the areas defined by the mesh, the mesh may be accordingly updated to account for the changes in the areas caused by the scan matching process. The changes may include, but are not limited to, rotations, translations, warps, sheers, and/or scaling.

Block 812 includes the controller 118 storing the updated mesh in memory 120. This updated mesh may be subsequently utilized to generate a global map in a human readable format which accounts for small differences between localization of objects on a local map and a global map. For example, rather than scan matching again, the mesh may be utilized to modify the local map to match the global map if, for example, a human desires to view multiple local routes on a single map, even if those local routes and their corresponding local maps include disagreement on object locations. It is appreciated by one skilled in the art that a robot 102 is capable of navigating using a computer readable map which is not perfectly accurate to the physical world, wherein small misalignments may not impact operation of the robot 102 but may make viewing the tasks the robot 102 has executed by a human difficult without global context for the entire environment.

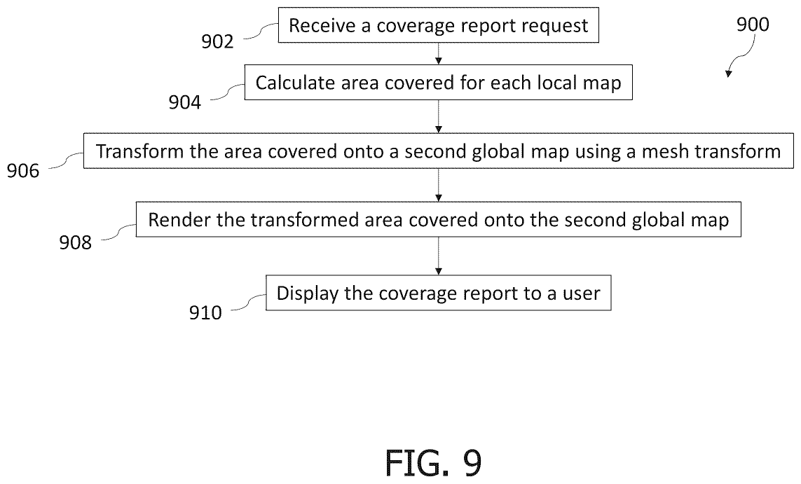

FIG. 9 is a process flow diagram illustrating a method 900 for a controller 118 of a robot 102 to generate a coverage report for a user, according to an exemplary embodiment. Method 900 may be executed after method 800, wherein the robot 102 has generated one or more meshes which transforms one or more respective local routes/maps to a global map. Steps of method 900 are effectuated via the controller 118 executing computer readable instructions from a non-transitory computer readable storage medium, such as memory 120.

Block 902 includes the controller 118 receiving a request to generate a coverage report. As used herein, a coverage report may comprise a report of various tasks and performance metrics related to the autonomous performance of the robot 102. For example, robot 102 may be an item transport robot 102, wherein the coverage report may indicate, but is not limited to, (i) a number of deliveries executed, (ii) which deliveries were executed, (iii) when the deliveries were executed, and (iv) the paths taken by the robot 102 in executing those deliveries. As another example, robot 102 may be a floor cleaning robot 102, wherein the coverage report may indicate, but is not limited to, (i) time taken to clean along various routes or in certain areas, (ii) when the routes or areas were cleaned, and (iii) the total area cleaned. In a third embodiment, the robot 102 may be configured to capture images and identify objects in the environment along various routes, wherein it is ideal to localize all the identified objects on a single, global map (e.g., for inventory tracking). It is appreciated that viewing such reports and metrics on a single, global map may be more easily understandable by a human reviewer. For instance, in the example where robot 102 is a floor cleaner, the robot 102 may pass through an aisle on a first local map and the same aisle on a second local map, wherein it requires the human to view and understand both local maps to determine the same aisle has been double cleaned and thus both passes through the aisle should not count towards the total area cleaned. For the purpose of explanation, the following blocks of method 900 will be with respect to an embodiment wherein the robot 102 is a floor cleaner, however such example is not intended to be limiting.

Block 904 includes the controller 118 calculating the area covered by the robot 102 for each local map of the one or more local maps stored in memory 120 of the robot 102. In some instances, the coverage report request received in block 902 may specify only certain route(s) and/or execution(s) thereof. For instance, the coverage report may request a report detailing the area cleaned by the robot 102 between 3:00 μm and 5:00 μm, thereby excluding routes executed prior to 3:00 μm and after 5:00 pm. An example of the area covered by a floor cleaning robot 102 being shown on a local map is illustrated in FIG. 7A-B above. To calculate the floor area cleaned by the robot 102, a robotic footprint representing either the size of the robot 102 or the size of its cleaning area (e.g., a scrub deck, squeegee, etc.) may be imposed onto the local maps and digitally moved along the local routes, wherein the area occupied by the footprint may represent the cleaned floor area. It is appreciated that the one or more meshes calculated before method 900 is executed which aligns the one or more local maps to the global map may also be applied to the area covered if the area covered is calculated after the meshes are determined. Alternatively, in some embodiments, the meshes may be determined in between blocks 904-906 after the area covered has been calculated. That is, method 800 may be executed after block 904 or before block 902. If the method 800 is performed before block 804, the controller 118 may provide users with the area cleaned for a given execution of a local route within the local frame of reference.

Block 906 includes the controller 118 transforming the area covered on the one or more local maps onto a second, global map. The global map may be produced during prior autonomous, semi-autonomous (e.g., guided navigation), or manual operation, wherein the controller 118 collects sensor data to map a substantial amount of the whole environment which local routes encompass. The environment mapped in the global map includes at least a portion of the area occupied by each of the local maps. Using a mesh comprising a plurality of discrete areas, each area being transformed to align with the global map using an affine transform described in FIGS. 6 and 8 above, for each local map the controller 118 may align the local maps to the global map, including the area cleaned.

Block 908 includes the controller 118 rendering the transformed area covered by the one or more local maps onto the second, global map. The rendering may be displayed on a user interface unit 116 of the robot 102 such as, without limitation, a screen, a touch screen, and/or may be communicated to an external device such as a tablet, computer, phone or laptop to be rendered and displayed to a user. Due to the use of the mesh for each local map aligned to the global map, the area covered in each local map may be represented on the global map accurately thus yielding an accurate coverage metric for the entire environment, regardless of the number of individual local routes needed to perform the overall cleaning task.

Block 910 includes the controller 118 displaying the coverage report to the user. As discussed above, the coverage report may be rendered onto a user interface unit of the robot 102 or on an external device coupled to the robot 102 (e.g., via Bluetooth®, cellular networks or Wi-Fi). Using the global map which comprises one or more aligned local routes and maps thereon, an accurate total area covered metric may be calculated for the cleaning robot 102. The total area covered can now additionally account for double-cleaned areas between two different local routes and avoid double counting. Further, visually displaying the areas covered by the robot 102 on the global map may be readily understood by a human reviewing the performance of the robot 102 as compared to the human viewing each of the local maps and accounting for overlaps themselves. Advantageously, method 900 produces a coverage report in human readable format that accounts for overlaps in cleaned areas and displays the paths, tasks, and behaviors executed by the robot in a human readable and understandable format which does not require additional steps by the human nor prior knowledge of the environment layout as the coverage is shown on a global map of the whole environment.

In some implementations the generated mesh may be useful to sparsify a pose graph used by the robot 102 to define its route. Typically, robots 102 store their routes in the form of a pose graph comprising of a plurality of nodes connected to each other via edges. Some nodes may comprise poses of the robot 102 along a route, and other nodes may be formed as optimization constraints. For instance, the intersection between the edges formed between two pairs of nodes. Often nodes which are not in order are connected to each other based on various constraints, such as the measured translation of the robot 102 between both nodes or its relative position to objects, in order to better optimize the pose graph. While this may generate accurate and optimizable pose graphs, storing this information for every route run begins to generate substantial data which needs to be stored in a memory. Accordingly, the pose graphs are commonly sparsifed using various methods within the art. Such methods, however, often run a risk of losing information, such as deleting edge constraints between two nodes as a result of removing a given node from the pose graph. The local map meshes, as described herein, could provide for constraints which enable pose graph sparsification.

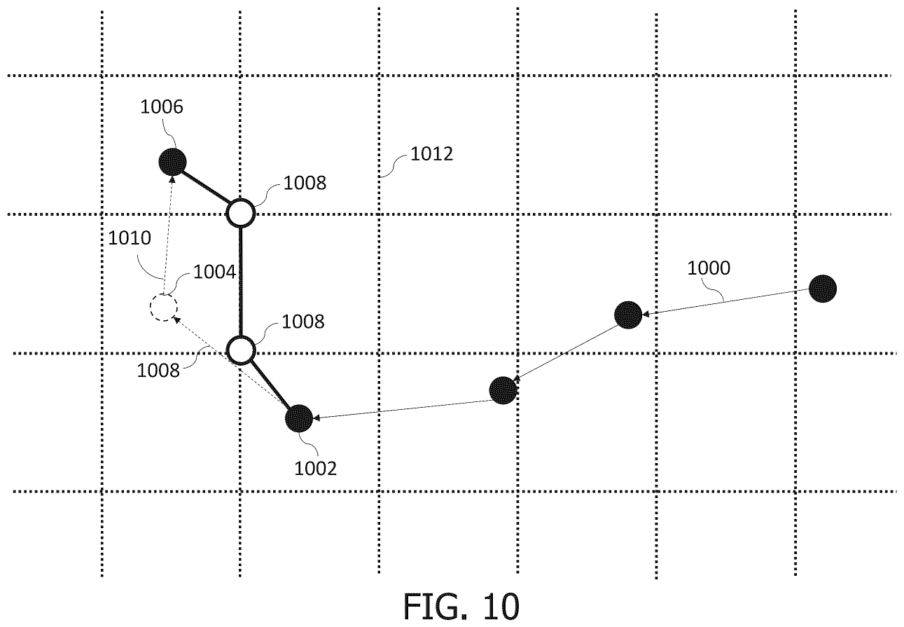

FIG. 10 depicts a pose graph 1000 of a route navigated by a robot 102 being sparsified via removing one node 1004, according to an exemplary embodiment. By removing node 1004, the edges 1008, 1010 are also removed. In order then to maintain a definition for the location of node 1006 a new constraint between the node 1002 and 1004 must be calculated. Typically, graph sparsification and marginalization, in removing node 1004, would require a transform between nodes 1002 and 1006 to be calculated which would be determined via a combination of edges 1008, 1010. Although the pose graph 1000 shown only includes one edge in between sequential nodes, it is appreciated that pose graphs used in contemporary simultaneous localization and mapping (“SLAM”) algorithms may form additional connections. For instance, nodes along the route which overlap could be connected by an edge. As more nodes and edges are removed from the graph during sparsification, the complexity of the calculated transforms increases, especially when the nodes of the pose graph have multiple edges.

Advantageously, the mesh 1012 provides for a dynamic definition for a sparcified and/or marginalized pose graph. The mesh 1012 is shown in this embodiment as comprising square regions, wherein the regions could be triangles as shown previously. The vertexes of the squares are each defined with respect to other vertexes in distance and location. That is, the mesh 1012 could be considered as an additional pose graph with each vertex of the squares/triangles defining a node connected by edges. As shown in FIG. 10, node 1004 could be removed during sparcification. In order to determine the spatial relationship between node 1006 and node 1002, both nodes could be respectively coupled via a new edge to one or more vertexes of the mesh 1012, two such nodes 1008 are shown. In some embodiments, the nodes 1002, 1006 who have at least one edge 1008, 1010 to another removed node 1004 would include one new edge to a nearest vertex of the mesh 1012. The pose graph 1000 has been sparcified without removing information related to the spatial relationship between node 1006 and other nodes, despite edges 1008, 1010 being removed. Further, the edges between nodes 1008 could be manipulated using the systems and methods disclosed herein if the mesh 1012 is manipulated. Edges between the nodes 1006 and 1008, or 1002 and 1008, would maintain their spatial geometry via affine transforms, whereas edges between nodes 1008 of the mesh vertices would be defined based on deformations to the mesh 1012.

To summarize, in performing pose graph sparcification and/or marginalization, the controller 118 could re-define the spatial position of the nodes with respect to the vertices of the mesh 1012 rather than defining new spatial transforms or edges between remaining nodes, e.g., 1002 and 1006. While this method may still occupy more memory than contemporary marginalization techniques since the controller 118 must store the mesh 1012 information, provided the controller 118 stores this mesh for other purposes (e.g., aligning two maps together) the overall memory used to define the pose graph 1000 would be reduced during sparcification and marginalization using the mesh 1012. Such memory would be further reduced when considering non-linear pose graphs (e.g., pose graphs which connect some or all nodes with three or more edges), such as those used in contemporary SLAM algorithms. Effectively, the mesh 1012 provides nodes 1008 and edges therebetween for free in memory. Advantageously, in addition to reducing memory usage, the sparcified and/or marginalized pose graph 1000 could be deformed in accordance with mesh deformations as described herein.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various exemplary embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and effected by those skilled in the art in practicing the claimed disclosure, from a study of the drawings, the disclosure and the appended claims.

It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least;” the term “such as” should be interpreted as “such as, without limitation;” the term ‘includes” should be interpreted as “includes but is not limited to;” the term “example” is used to provide exemplary instances of the item in discussion, not an exhaustive or limiting list thereof, and should be interpreted as “example, but without limitation;” adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

What is claimed is:

1. A robot, comprising:
a non-transitory computer readable storage medium comprising a plurality of computer readable instructions stored thereon; and
a controller configured to execute the computer readable instructions to:
produce one or more computer readable maps during navigation of the robot along a route;
impose a mesh over the one or more computer readable maps;
align the one or more computer readable maps to a second computer readable map based on a first transformation; and
adjust the mesh based on the first transformation.

2. The robot of claim 1, wherein the controller is further configured to execute the computer readable instructions to:
determine the first transformation based on an alignment of a set of features found on both the one or more computer readable maps and the second computer readable maps.

3. The robot of claim 2, wherein,
the mesh is defined by a grid of points; and
the first transform comprises adjustment of the grid of the mesh.

4. The robot of claim 3, wherein,
the mesh comprises a plurality of triangles; and
the first transform comprises manipulating an area encompassed within the triangles.

5. The robot of claim 4, wherein the controller is further configured to execute the computer readable instructions to:
detect if one or more of the triangles have collapsed; and
determine the first transform yields a discontinuous map.

6. The robot of claim 1, wherein,
the mesh defines a plurality of areas; and
the adjusting of the mesh comprises of one or more affine transformations of a respective one of the plurality of areas.

7. A non-transitory computer readable storage medium comprising a plurality of computer readable instructions stored thereon which, when executed by a controller of a robot, cause the controller to:
produce one or more computer readable maps during navigation of the robot along a route;
impose a mesh over the one or more computer readable maps;
align the one or more computer readable maps to a second computer readable map based on a first transformation; and
adjust the mesh based on the first transformation.

8. The non-transitory computer readable storage medium of claim 7, wherein the controller is further configured to execute the computer readable instructions to:
determine the first transformation based on an alignment of a set of features found on both the one or more computer readable maps and the second computer readable maps.

9. The non-transitory computer readable storage medium of claim 8, wherein the mesh is defined by a grid of points; and the first transform comprises adjustment of the grid of the mesh.

10. The non-transitory computer readable storage medium of claim 9, wherein the mesh comprises a plurality of triangles; and the first transform comprises manipulating an area encompassed within the triangles.

11. The non-transitory computer readable storage medium of claim 10, wherein the controller is further configured to execute the computer readable instructions to:
detect if one or more of the triangles have collapsed; and
determine the first transform yields a discontinuous map.

12. The non-transitory computer readable storage medium of claim 7, wherein,
the mesh defines a plurality of areas; and
the adjusting of the mesh comprises of one or more affine transformations of a respective one of the plurality of areas.

13. A method for navigating a robot, comprising:
producing, using the controller, one or more computer readable maps during navigation of the robot along a route;
imposing, using the controller, a mesh over the one or more computer readable maps;
aligning, using the controller, the one or more computer readable maps to a second computer readable map based on a first transformation; and
adjusting, using the controller, the mesh based on the first transformation.

14. The method of claim 13, further comprising:
determining, using the controller, the first transformation based on an alignment of a set of features found on both the one or more computer readable maps and the second computer readable maps.

15. The method of claim 14, wherein the mesh is defined by a grid of points; and the first transform comprises adjustment of the grid of the mesh.

16. The method of claim 15, wherein the mesh comprises a plurality of triangles; and the first transform comprises manipulating an area encompassed within the triangles.

17. The method of claim 16, further comprising:
detecting, using the controller, whether one or more of the triangles have collapsed; and
determining, using the controller, the first transform yields a discontinuous map.

18. The method of claim 13, wherein the mesh defines a plurality of areas; and the adjusting of the mesh comprises of one or more affine transformations of a respective one of the plurality of areas.
